(19) United States
(12) Patent Application Publication
(10) Pub. No.: US 2026/0110938 A1
(43) Pub. Date: Apr. 23, 2026

(54) DISPLAY PANEL AND DISPLAY DEVICE

(71) Applicant: TCL CHINA STAR OPTOELECTRONICS TECHNOLOGY CO., LTD., Shenzhen (CN)

(72) Inventor: Yongchao ZHAO, Shenzhen (CN)

(73) Assignee: TCL CHINA STAR OPTOELECTRONICS TECHNOLOGY CO., LTD., Shenzhen (CN)

(21) Appl. No.: 19/023,594

(22) Filed: Jan. 16, 2025

(30) Foreign Application Priority Data
Oct. 23, 2024 (CN) 202411492971.2

(51) Int. Cl. G02F 1/1337; G02F 1/1335

(52) U.S. Cl. CPC G02F 1/133761; G02F 1/133512

(57) ABSTRACT

Embodiments of the present disclosure provide a display panel and a display device. A first pixel region has a first alignment angle difference, a second pixel region has a second alignment angle difference, and a third pixel region has a third alignment angle difference. A portion of a cholesteric liquid crystal located in the first pixel region has a first pitch, a portion of the cholesteric liquid crystal located in the second pixel region has a second pitch, a portion of the cholesteric liquid crystal located in the third pixel region has a third pitch. Any two of the first alignment angle difference, the second alignment angle difference, and the third alignment angle difference are different. Any two of the first pitch, the second pitch, and the third pitch are different.

### CROSS-REFERENCE TO RELATED APPLICATION

The application claims priority to and the benefit of Chinese Patent Application No. 202411492971.2, filed on Oct. 23, 2024, the disclosure of which is incorporated herein by reference in its entirety.

### TECHNICAL FIELD

The present disclosure relates to display technologies, and in particular, to a display panel and a display device.

### BACKGROUND

In traditional cholesteric liquid crystal full-color electronic paper, a glass liquid crystal cell emitting red light, a glass liquid crystal cell emitting green light, and a glass liquid crystal cell emitting blue light are typically used, the three glass liquid crystal cells are stacked, and two adjacent glass liquid crystal cells are connected to each other by double-sided adhesive.

During the research and practice of existing technologies, the inventor of the present application has discovered that the structure of the traditional full-color cholesteric liquid crystal is relatively complex.

### SUMMARY

Embodiments of the present disclosure provide a display panel and a display device, in order to simplify the structure of the display panel.

An embodiment of the present disclosure provides a display panel, including a first baseplate and a second baseplate arranged opposite to each other, and a cholesteric liquid crystal arranged between the first baseplate and the second baseplate, the display panel including a first pixel region, a second pixel region, and a third pixel region.

The first baseplate includes a first substrate and a first alignment layer arranged on a side of the first substrate close to the cholesteric liquid crystal, and the second baseplate includes a second substrate and a second alignment layer arranged on a side of the second substrate close to the cholesteric liquid crystal.

In the first pixel region, an alignment angle of the first alignment layer and an alignment angle of the second alignment layer have a first alignment angle difference; in the second pixel region, an alignment angle of the first alignment layer and an alignment angle of the second alignment layer have a second alignment angle difference; in the third pixel region, an alignment angle of the first alignment layer and an alignment angle of the second alignment layer have a third alignment angle difference; and any two of the first alignment angle difference, the second alignment angle difference, and the third alignment angle difference are different.

A portion of the cholesteric liquid crystal located in the first pixel region has a first pitch, a portion of the cholesteric liquid crystal located in the second pixel region has a second pitch, a portion of the cholesteric liquid crystal located in the third pixel region has a third pitch, and any two of the first pitch, the second pitch, and the third pitch are different.

Accordingly, an embodiment of the present disclosure further provides a display device, including a display panel according to any of the aforementioned embodiments.

### BRIEF DESCRIPTION OF THE DRAWINGS

FIG. 1 is a schematic diagram of a structure of a display panel according to an embodiment of the present disclosure;

FIG. 2 is a schematic flowchart illustrating a preparation of a first baseplate in a display panel according to an embodiment of the present disclosure;

FIG. 3 is a schematic flowchart illustrating a preparation of a second baseplate in a display panel according to an embodiment of the present disclosure;

FIG. 4 is a schematic diagram of another structure of the display panel according to an embodiment of the present disclosure;

FIG. 5 is a schematic diagram of yet another structure of the display panel according to an embodiment of the present disclosure; and

FIG. 6 is a schematic diagram of a structure of a display device according to an embodiment of the present disclosure.

### DETAILED DESCRIPTION

Technical proposals in the embodiments of the present disclosure will be clearly and completely described with reference to the accompanying drawings. It will be apparent that the described embodiments are only some of the embodiments of the present disclosure, but not all of them. Based on the embodiments in the present disclosure, other embodiments obtained by the skilled person in the art without creative labor all fall within the scope of the present disclosure. In addition, it should be understood that the specific embodiments described here are only used to illustrate and explain the application, and are not used to limit the application. In the application, the embodiments may be combined with each other without redundant description, and unless otherwise specified, the directional words used such as “upper” and “lower” usually refer to the upper and lower position of the device in actual use or working state, specifically to the direction of the drawing in the drawings, while “inside” and “outside” are understood referring to the contour lines of the device; and the terms “first”, “second”, “third”, etc. are only used for labeling purposes and do not imply any numerical requirement or establish any order.

Embodiments of the present disclosure provide a display panel and a display device, as described in detail below. It should be noted that the order of description of the following embodiments is not intended to limit the preferred order of the embodiments.

An embodiment of the present disclosure provides a display panel, including a first baseplate and a second baseplate arranged opposite to each other, and a cholesteric liquid crystal arranged between the first baseplate and the second baseplate, the display panel including a first pixel region, a second pixel region, and a third pixel region; and

The first baseplate includes a first substrate and a first alignment layer arranged on a side of the first substrate close to the cholesteric liquid crystal, and the second baseplate includes a second substrate and a second alignment layer arranged on a side of the second substrate close to the cholesteric liquid crystal.

In the first pixel region, an alignment angle of the first alignment layer and an alignment angle of the second alignment layer have a first alignment angle difference; in the second pixel region, an alignment angle of the first alignment layer and an alignment angle of the second alignment layer have a second alignment angle difference; in the third pixel region, an alignment angle of the first alignment layer and an alignment angle of the second alignment layer have a third alignment angle difference; and any two of the first alignment angle difference, the second alignment angle difference, and the third alignment angle difference are different.

A portion of the cholesteric liquid crystal located in the first pixel region has a first pitch, a portion of the cholesteric liquid crystal located in the second pixel region has a second pitch, a portion of the cholesteric liquid crystal located in the third pixel region has a third pitch, and any two of the first pitch, the second pitch, and the third pitch are different.

Optionally, in some embodiments of the present disclosure, one of the first alignment layer and the second alignment layer includes a first alignment component arranged in the first pixel region, a second alignment component arranged in the second pixel region, and a third alignment component arranged in the third pixel region; and an alignment angle of the first alignment component, an alignment angle of the second alignment component, and an alignment angle of the third alignment component are the same; and

the other one of the first alignment layer and the second alignment layer includes a fourth alignment component arranged in the first pixel region, a fifth alignment component arranged in the second pixel region, and a sixth alignment component arranged in the third pixel region; and any two of an alignment angle of the fourth alignment component, an alignment angle of the fifth alignment component, and an alignment angle of the sixth alignment component are different.

Optionally, in some embodiments of the present disclosure, the one of the first alignment layer and the second alignment layer has a uniform alignment angle across an entire surface.

Optionally, in some embodiments of the present disclosure, one of the first alignment layer and the second alignment layer includes a first alignment component arranged in the first pixel region, a second alignment component arranged in the second pixel region, and a third alignment component arranged in the third pixel region; and at least two of an alignment angle of the first alignment component, an alignment angle of the second alignment component, and an alignment angle of the third alignment component are different; and

the other one of the first alignment layer and the second alignment layer includes a fourth alignment component arranged in the first pixel region, a fifth alignment component arranged in the second pixel region, and a sixth alignment component arranged in the third pixel region; and any two of an alignment angle of the fourth alignment component, an alignment angle of the fifth alignment component, and an alignment angle of the sixth alignment component are different.

Optionally, in some embodiments of the present disclosure, the cholesteric liquid crystal is continuously arranged in any two of the first pixel region, the second pixel region, and the third pixel region.

Optionally, in some embodiments of the present disclosure, the first baseplate is located on a display side of the display panel, the first baseplate further includes black matrix layers arranged on a side of the first alignment layer close to the first substrate, and in a top view of the display panel, the black matrix layer is arranged at a boundary between any two adjacent pixel regions among the first pixel region, the second pixel region, and the third pixel region.

Optionally, in some embodiments of the present disclosure, in the top view of the display panel, any two adjacent alignment components of the fourth alignment component, the fifth alignment component, and the sixth alignment component partially overlap with the black matrix layer.

Optionally, in some embodiments of the present disclosure, the display panel further includes retaining walls arranged between the first baseplate and the second baseplate, the retaining walls are respectively arranged at a boundary between any two adjacent pixel regions among the first pixel region, the second pixel region, and the third pixel region, and the retaining wall separates the cholesteric liquid crystal.

Optionally, in some embodiments of the present disclosure, a color of the retaining walls is black.

Optionally, in some embodiments of the present disclosure, in a top view of the display panel, any two adjacent alignment components of the fourth alignment component, the fifth alignment component, and the sixth alignment component partially overlap with a respective one of the retaining walls.

Optionally, in some embodiments of the present disclosure, the first baseplate further includes a transparent electrode layer located between the first substrate and the first alignment layer, and the transparent electrode layer accesses a common voltage.

Optionally, in some embodiments of the present disclosure, the second baseplate further includes a plurality of pixel electrodes, a plurality of thin film transistors, and a driver circuit, and the driver circuit provides a driving voltage to the pixel electrodes of each pixel region.

Accordingly, an embodiment of the present disclosure further provides a display device, including a display panel, and the display panel including a first baseplate and a second baseplate arranged opposite to each other, and a cholesteric liquid crystal arranged between the first baseplate and the second baseplate.

The display panel includes a first pixel region, a second pixel region, and a third pixel region.

The first baseplate includes a first substrate and a first alignment layer arranged on a side of the first substrate close to the cholesteric liquid crystal, and the second baseplate includes a second substrate and a second alignment layer arranged on a side of the second substrate close to the cholesteric liquid crystal.

In the first pixel region, an alignment angle of the first alignment layer and an alignment angle of the second alignment layer have a first alignment angle difference; in the second pixel region, an alignment angle of the first alignment layer and an alignment angle of the second alignment layer have a second alignment angle difference; in the third pixel region, an alignment angle of the first alignment layer and an alignment angle of the second alignment layer have a third alignment angle difference; and any two of the first alignment angle difference, the second alignment angle difference, and the third alignment angle difference are different.

A portion of the cholesteric liquid crystal located in the first pixel region has a first pitch, a portion of the cholesteric liquid crystal located in the second pixel region has a second pitch, a portion of the cholesteric liquid crystal located in the third pixel region has a third pitch, and any two of the first pitch, the second pitch, and the third pitch are different.

Optionally, in some embodiments of the present disclosure, one of the first alignment layer and the second alignment layer includes a first alignment component arranged in the first pixel region, a second alignment component arranged in the second pixel region, and a third alignment component arranged in the third pixel region; and an alignment angle of the first alignment component, an alignment angle of the second alignment component, and an alignment angle of the third alignment component are the same; and

the other one of the first alignment layer and the second alignment layer includes a fourth alignment component arranged in the first pixel region, a fifth alignment component arranged in the second pixel region, and a sixth alignment component arranged in the third pixel region; and any two of an alignment angle of the fourth alignment component, an alignment angle of the fifth alignment component, and an alignment angle of the sixth alignment component are different.

Optionally, in some embodiments of the present disclosure, one of the first alignment layer and the second alignment layer includes a first alignment component arranged in the first pixel region, a second alignment component arranged in the second pixel region, and a third alignment component arranged in the third pixel region; and at least two of an alignment angle of the first alignment component, an alignment angle of the second alignment component, and an alignment angle of the third alignment component are different; and

the other one of the first alignment layer and the second alignment layer includes a fourth alignment component arranged in the first pixel region, a fifth alignment component arranged in the second pixel region, and a sixth alignment component arranged in the third pixel region; and any two of an alignment angle of the fourth alignment component, an alignment angle of the fifth alignment component, and an alignment angle of the sixth alignment component are different.

Optionally, in some embodiments of the present disclosure, the first baseplate is located on a display side of the display panel, the first baseplate further includes a black matrix layer arranged on a side of the first alignment layer close to the first substrate, and in a top view of the display panel, the black matrix layer is arranged at a boundary between any two adjacent pixel regions among the first pixel region, the second pixel region, and the third pixel region.

Optionally, in some embodiments of the present disclosure, in the top view of the display panel, any two adjacent alignment components of the fourth alignment component, the fifth alignment component, and the sixth alignment component partially overlap with the black matrix layer.

Optionally, in some embodiments of the present disclosure, the display panel further includes retaining walls arranged between the first baseplate and the second baseplate, the retaining walls are respectively arranged at a boundary between any two adjacent pixel regions among the first pixel region, the second pixel region, and the third pixel region, and the retaining walls separate the cholesteric liquid crystal.

Optionally, in some embodiments of the present disclosure, a color of the retaining walls is black.

Optionally, in some embodiments of the present disclosure, in a top view of the display panel, any two adjacent alignment components of the fourth alignment component, the fifth alignment component, and the sixth alignment component partially overlap with a respective one of the retaining walls.

In the display panel and the display device of embodiments of the present disclosure, in the first pixel region, the alignment angle of the first alignment layer and the alignment angle of the second alignment layer have the first alignment angle difference; in the second pixel region, the alignment angle of the first alignment layer and the alignment angle of the second alignment layer have the second alignment angle difference; and in the third pixel region, the alignment angle of the first alignment layer and the alignment angle of the second alignment layer have the third alignment angle difference. The portion of the cholesteric liquid crystal located in the first pixel region has the first pitch, the portion of the cholesteric liquid crystal located in the second pixel region has the second pitch, and the portion of the cholesteric liquid crystal located in the third pixel region has the third pitch.

In the display panel and the display device of embodiments of the present disclosure, any two of the first alignment angle difference, the second alignment angle difference, and the third alignment angle difference are different, so that any two of the first pitch, the second pitch, and the third pitch are different, thereby enabling the first pixel region, the second pixel region, and the third pixel region to display different colors. It can be understood that, compared to the existing technologies, the display panel and the display device of embodiments of the present disclosure achieve color display by using a single layer of the cholesteric liquid crystal, thereby simplifying the structure of the display panel.

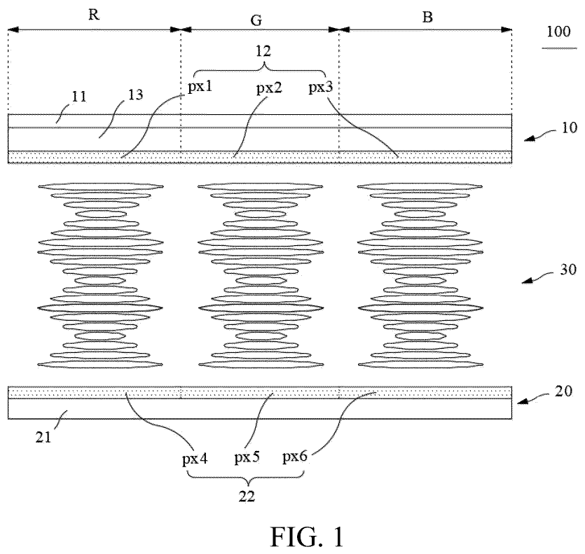

Please refer to FIG. 1, FIG. 1 is a schematic diagram of a cross-sectional structure of a display panel 100 according to one or more embodiments of the present disclosure. Optionally, the display panel 100 may be used for an electronic paper device, but is not limited thereto.

In FIG. 1, the display panel 100 includes a first pixel region R, a second pixel region G, and a third pixel region B.

Optionally, the first pixel region (R), the second pixel region (G), and the third pixel region (B) are configured such that a first one displays green, a second one displays blue, and a third one displays red. The following description uses an example in which the first pixel region R displays red, the second pixel region G displays green, and the third pixel region B displays blue.

It should be understood that the first pixel region R, the second pixel region G, and the third pixel region B can be arranged in a matrix form. A pixel within the pixel regions may have a rectangular shape, a diamond shape, or a square shape in a plan view, but the embodiments are not limited to these shapes. For example, in the plan view, the pixel may have another quadrilateral shape other than a rectangular shape, a diamond shape, or a square shape, another polygonal shape other than a quadrilateral shape, a circular shape, or an oval shape.

Please refer to FIG. 1, an embodiment of the present disclosure provides a display panel 100, including a first baseplate 10 and a second baseplate 20 arranged opposite to each other, and a cholesteric liquid crystal 30 arranged between the first baseplate 10 and the second baseplate 20.

The first baseplate 10 includes a first substrate 11 and a first alignment layer 12 arranged on a side of the first substrate 11 close to the cholesteric liquid crystal 30. The second baseplate 20 includes a second substrate 21 and a second alignment layer 22 arranged on a side of the second substrate 21 close to the cholesteric liquid crystal 30.

In the first pixel region R, an alignment angle of the first alignment layer 12 and an alignment angle of the second alignment layer 22 have a first alignment angle difference. In the second pixel region G, an alignment angle of the first alignment layer 12 and an alignment angle of the second alignment layer 22 have a second alignment angle difference. In the third pixel region B, an alignment angle of the first alignment layer 12 and an alignment angle of the second alignment layer 22 have a third alignment angle difference. Any two of the first alignment angle difference, the second alignment angle difference, and the third alignment angle difference are different.

A portion of the cholesteric liquid crystal 30 located in the first pixel region R has a first pitch, a portion of the cholesteric liquid crystal 30 located in the second pixel region G has a second pitch, a portion of the cholesteric liquid crystal 30 located in the third pixel region B has a third pitch, and any two of the first pitch, the second pitch, and the third pitch are different.

It should be explained that in Formula 1:

$$P = \frac{2 π}{2 π - φ} {P}_{0} ,$$

P0 is an initial pitch of the cholesteric liquid crystal, P is an adjusted pitch of the cholesteric liquid crystal, and φ, referred to as an alignment angle difference, is a difference between an alignment angle of the first alignment layer of the first baseplate 10 and an alignment angle of the second alignment layer of the second baseplate 20. According to the aforementioned formula 1, it is clear that the pitch of the cholesteric liquid crystal can be adjusted by modifying the alignment angle difference.

Therefore, in the display panel 100 of embodiments of the present disclosure, by setting any two of the first alignment angle difference, the second alignment angle difference, and the third alignment angle difference to be different, any two of the first pitch, the second pitch, and the third pitch are also different. That is, by setting the first alignment angle difference of the first pixel region R, the second alignment angle difference of the second pixel region G, and the third alignment angle difference of the third pixel region B to be all different, the first pitch of the cholesteric liquid crystal 30 in the first pixel region R, the second pitch of the cholesteric liquid crystal 30 in the second pixel region G, and the third pitch of the cholesteric liquid crystal 30 in the third pixel region B are also all different.

Based on this, according to formula 2: λ=nP, it can be understood that cholesteric liquid crystals with different pitches can reflect different wavelengths of light, where λ represents the wavelength of light, n represents the average refractive index of the cholesteric liquid crystal, and P represents the pitch of the cholesteric liquid crystal. Therefore, by setting the pitches of the cholesteric liquid crystal 30 in the first pixel region R, the second pixel region G, and the third pixel region B to be different, the first pixel region R, the second pixel region G, and the third pixel region B can reflect different wavelengths of light, thereby enabling the first pixel region R, the second pixel region G, and the third pixel region B to display different colors.

For example, an initial reflection wavelength of the cholesteric liquid crystal 30 is in a purple range, with a wavelength range between 400 nanometers and 455 nanometers. When the alignment angle difference φ is π/4, a reflection wavelength is in a blue range, with a wavelength range between 457 nanometers and 520 nanometers; when the alignment angle difference φ is 5π/12, a reflection wavelength is in a green range, with a wavelength range between 505 nanometers and 574 nanometers; and when the alignment angle difference φ is 3π/4, a reflection wavelength is in a red range, with a wavelength range between 640 nanometers and 728 nanometers.

It should be noted that, compared to the existing technologies, the display panel 100 of embodiments of the present disclosure achieves color display by using a single layer of the cholesteric liquid crystal, thereby simplifying the structure of the display panel 100.

Optionally, in some embodiments of the present disclosure, the second baseplate 20 includes a plurality of pixel electrodes, a plurality of thin film transistors, and a driver circuit. The driver circuit can provide a driving voltage to the pixel electrodes of each pixel region, allowing an electric field of each pixel region to be individually controlled, and thus the liquid crystal state of the corresponding area can be controlled to realize the change of the gray level.

The first baseplate 10 further includes a transparent electrode layer 13 located between the first substrate 11 and the first alignment layer 12. The transparent electrode layer 13 is used to access a common voltage, forming an electric field between the first baseplate 10 and the second baseplate 20 to control the state of the cholesteric liquid crystal 30.

Optionally, in some embodiments of the present disclosure, the transparent electrode layer 13 may also be arranged on the second baseplate 20. It should be noted that as long as the display panel 100 is capable of forming an electric field to control the state of the cholesteric liquid crystal 30, no specific limitations are imposed in the present application.

Optionally, in some embodiments of the present disclosure, one of the first alignment layer 12 and the second alignment layer 22 includes a first alignment component px1 arranged in the first pixel region R, a second alignment component px2 arranged in the second pixel region G, and a third alignment component px3 arranged in the third pixel region B; and an alignment angle of the first alignment component px1, an alignment angle of the second alignment component px2, and an alignment angle of the third alignment component px3 are the same.

The other one of the first alignment layer 12 and the second alignment layer 22 includes a fourth alignment component px4 arranged in the first pixel region R, a fifth alignment component px5 arranged in the second pixel region G, and a sixth alignment component px6 arranged in the third pixel region B; and any two of an alignment angle of the fourth alignment component px4, an alignment angle of the fifth alignment component px5, and an alignment angle of the sixth alignment component px6 are different.

It can be understood that by arranging the alignment angles of the first alignment component px1 to the third alignment component px3 of the one of the first alignment layer 12 and the second alignment layer 22 to be the same, and arranging the alignment angles of the fourth alignment component px4 to the sixth alignment component px6 of the other one of the first alignment layer 12 and the second alignment layer 22 to be different, it is possible to achieve different pitches of the cholesteric liquid crystal 30 corresponding to different pixel regions by merely adjusting the alignment angles of the one of the first alignment layer 12 and the second alignment layer 22 that has different alignment angles.

The following description is provided by an example in which the first alignment layer 12 includes the first alignment component px1 to the third alignment component px3, and the second alignment layer 22 includes the fourth alignment component px4 to the sixth alignment component px6, but it is not limited to these arrangements. For example, it is also possible that the second alignment layer 22 includes the first alignment component px1 to the third alignment component px3, and the first alignment layer 12 includes the fourth alignment component px4 to the sixth alignment component px6.

That is, because the first alignment component px1 to the third alignment component px3 of the first alignment layer 12 have the same alignment angle, it is possible to achieve different alignment angle differences of the first pixel region R, the second pixel region G, and the third pixel region B merely by adjusting the respective alignment angles of the fourth alignment component px4 to the sixth alignment component px6 of the second alignment layer 22.

Optionally, in some embodiments of the present disclosure, the one of the first alignment layer 12 and the second alignment layer 22 has a uniform alignment angle across an entire surface. Here, it means that the one, having the same alignment angle, of the first alignment layer 12 and the second alignment layer 22 has a uniform alignment angle on the entire surface, in order to reduce the difficulty of preparation.

Optionally, the first alignment layer 12 is formed by coating the entire surface with the alignment material liquid, and subsequently forming the first alignment layer 12 with a uniform alignment angle by using the same alignment angle method.

Optionally, the preparation methods for the first alignment layer 12 and the second alignment layer 22 are as follows:

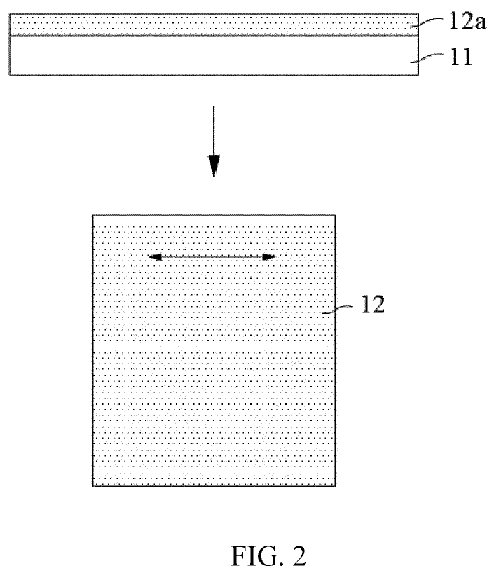

Referring to FIG. 2, a first light-aligning liquid 12a is coated on the first substrate 11, and then the first light-aligning liquid 12a is irradiated with ultraviolet light to form the first alignment layer 12 with a single alignment angle. An irradiation wavelength of the first light-aligning liquid 12a may be one of 254 nanometers, 313 nanometers, and 365 nanometers.

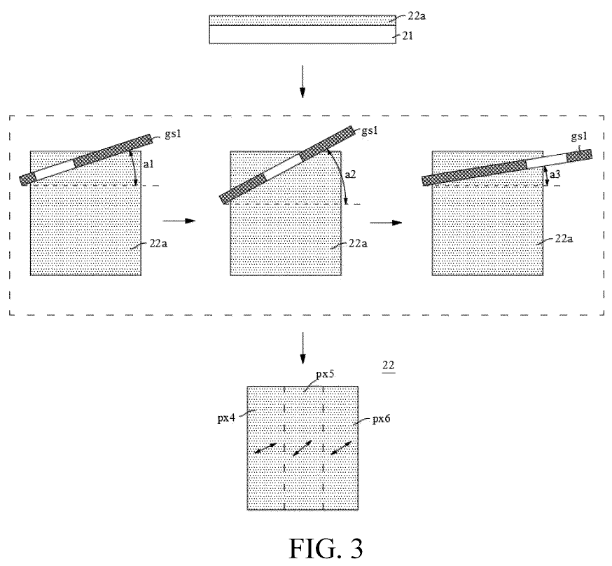

Referring to FIG. 3, a second light-aligning liquid 22a is coated on the second substrate 21.

Subsequently, a grating gs1 is adopted as a mask, and the grating gs1 is arranged at a first angle a1 with respect to the second substrate 21 in the first pixel region R, and then ultraviolet light irradiation is performed to form the fourth alignment component px4. Next, the grating gs1 is arranged at a second angle a2 with respect to the second substrate 21 in the second pixel region G, and then ultraviolet light irradiation is performed to form the fifth alignment component px5. The grating gs1 is arranged at a third angle a3 with respect to the second substrate 21 in the third pixel region B, and then ultraviolet light irradiation is performed to form the sixth alignment component px6.

In other words, different alignment angles for different alignment components are achieved by controlling the light transmission amount of the grating and adjusting the angle of the grating.

Optionally, an irradiation wavelength of the second light-aligning liquid 22a may be one of 254 nanometers, 313 nanometers, and 365 nanometers.

Optionally, in some embodiments of the present disclosure, the first alignment layer 12 and the second alignment layer 22 both adopt different alignment angles in two different pixel regions. For example, at least two of an alignment angle of the first alignment component px1, an alignment angle of the second alignment component px2, and an alignment angle of the third alignment component px3 are different. Any two of an alignment angle of the fourth alignment component px4, an alignment angle of the fifth alignment component px5, and an alignment angle of the sixth alignment component px6 are different.

Since the alignment component px1 to the alignment component px6 can each be flexibly adjusted, the breadth and flexibility in adjusting the first alignment angle difference, the second alignment angle difference, and the third alignment angle difference are improved to meet more requirements.

Optionally, in some embodiments of the present disclosure, the cholesteric liquid crystal 30 is continuously arranged in any two of the first pixel region R, the second pixel region G, and the third pixel region B.

The cholesteric liquid crystal 30 is continuously arranged from the first pixel region R to the third pixel region B, meaning that the cholesteric liquid crystal 30 is continuously arranged throughout the entire layer between the first baseplate 10 and the second baseplate 20. It should be noted that by using different alignment angle differences to achieve different pitches of the cholesteric liquid crystal 30 corresponding to different pixel regions, the cholesteric liquid crystal 30 may be continuously arranged in a whole layer, thereby saving cofferdams used to partition or accommodate the cholesteric liquid crystal in the display area.

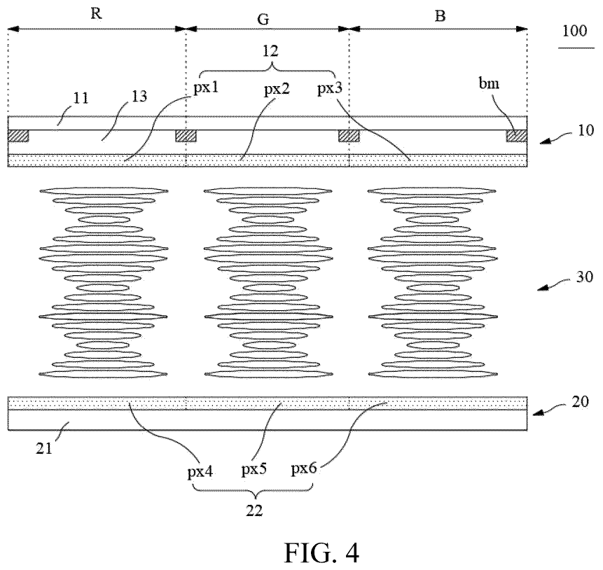

Please refer to FIG. 4, FIG. 4 is a schematic diagram of a display panel 100 according to one or more embodiments of the present disclosure. Compared to the display panel 100 of any aforementioned embodiments, the display panel 100 of an embodiment corresponding to FIG. 4 includes additional black matrix layers bm.

Optionally, in some embodiments of the present disclosure, the first baseplate 10 is located on a display side of the display panel 100. The first baseplate 10 further includes a black matrix layer bm arranged on a side of the first alignment layer 12 close to the first substrate 11. In a top view of the display panel 100, the black matrix layer bm is arranged at a boundary between any two adjacent pixel regions among the first pixel region R, the second pixel region G, and the third pixel region B.

It can be understood that, because the alignment components of two adjacent pixel regions have different alignment angles, and in the process of preparing the alignment components with different alignment angles, there may be a situation in which an alignment deviation occurs at the boundary between the two adjacent alignment components, resulting in a difference in the pitch of the liquid crystal therein, and thus causing a deviation in the wavelength of the light reflected by the cholesteric liquid crystal 30, consequently leading to poor display performance. Therefore, in the display panel 100 of the embodiment of the present disclosure, the black matrix layer bm, which can block the cholesteric liquid crystal 30 at the boundary of the pixel regions, is arranged at the boundary between the two adjacent pixel regions, in order to block the deviating light wavelengths and improve the display performance.

Optionally, in some embodiments of the present disclosure, in the top view of the display panel 100, any two adjacent alignment components of the fourth alignment component px4, the fifth alignment component px5, and the sixth alignment component px6 partially overlap with the black matrix layer bm.

It can be understood that the black matrix layer bm simultaneously blocks the edge parts of the two alignment components located at the boundary between the pixel regions, in order to better block the deviating light wavelengths.

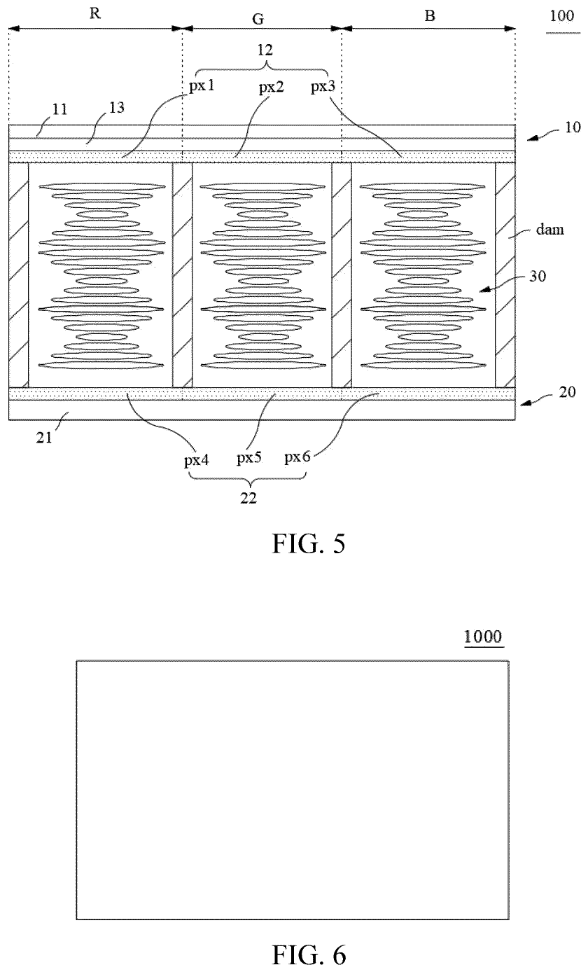

Please refer to FIG. 5, FIG. 5 is a schematic diagram of a display panel 100 according to one or more embodiments of the present disclosure. Compared to the display panel 100 corresponding to FIG. 1, the display panel 100 of an embodiment corresponding to FIG. 5 includes additional retaining walls dam.

Optionally, in some embodiments of the present disclosure, the display panel 100 further includes retaining walls dam arranged between the first baseplate 10 and the second baseplate 20. The retaining wall dams are respectively arranged at a boundary between any two adjacent pixel regions among the first pixel region R, the second pixel region G, and the third pixel region B, and the retaining walls dam separate the cholesteric liquid crystal 30.

It can be understood that by arranging the retaining walls dam at the boundary between adjacent pixel regions, the cholesteric liquid crystal 30 can avoid the boundary between the pixel regions, thereby reducing the risk of the cholesteric liquid crystal 30 reflecting deviating light wavelengths.

Optionally, in some embodiments of the present disclosure, any two adjacent alignment components of the fourth alignment component px4, the fifth alignment component px5, and the sixth alignment component px6 partially overlap with the respective one of the retaining walls dam.

It can be understood that each of the retaining walls dam simultaneously occupies the edge parts of the two alignment components located at the boundary between the pixel regions, so that the cholesteric liquid crystal 30 is more evenly distributed away from the boundary between the pixel regions, thereby reducing the risk of the cholesteric liquid crystal 30 reflecting deviating light wavelengths.

Optionally, in some embodiments of the present disclosure, a color of the retaining walls dam is black. The black retaining walls dam can reduce the risk of crosstalk caused by reflected light of the two adjacent pixel regions and can also absorb the deviating light wavelengths, further improving display performance.

Additionally, the retaining walls dam can also shield thin film transistors and metal wirings, such as scanning lines, signal lines, etc., on the second baseplate 20, thereby saving the black matrix layer.

Please refer to FIG. 6, FIG. 6 illustrates a display device 1000 according to one or more embodiments of the present disclosure. An embodiment of the present disclosure further provides a display device 1000, including a display panel 100 according to any of the aforementioned embodiments.

Optionally, the display device 1000 may be an electronic paper, but is not limited thereto.

It should be noted that the structure of the display panel 100 of the display device 1000 in the embodiment of the present disclosure is similar or identical to the structure of the display panel 100 in any of the embodiments corresponding to FIG. 1 to FIG. 5, and therefore will not be redundantly described here.

In the display panel 100 of the display device 1000 of embodiments of the present disclosure, in the first pixel region R, the alignment angle of the first alignment layer 12 and the alignment angle of the second alignment layer 22 have the first alignment angle difference; in the second pixel region G, the alignment angle of the first alignment layer 12 and the alignment angle of the second alignment layer 22 have the second alignment angle difference; and in the third pixel region B, the alignment angle of the first alignment layer 12 and the alignment angle of the second alignment layer 22 have the third alignment angle difference. The portion of the cholesteric liquid crystal 30 located in the first pixel region R has the first pitch, the portion of the cholesteric liquid crystal 30 located in the second pixel region G has the second pitch, and the portion of the cholesteric liquid crystal 30 located in the third pixel region B has the third pitch.

In the display device of embodiments of the present disclosure, any two of the first alignment angle difference, the second alignment angle difference, and the third alignment angle difference are different, so that any two of the first pitch, the second pitch, and the third pitch are different, thereby enabling the first pixel region, the second pixel region, and the third pixel region to display different colors. It can be understood that, compared to the existing technologies, the display device of embodiments of the present disclosure achieves color display by using a single layer of the cholesteric liquid crystal, thereby simplifying the structure of the display device 1000.

The present disclosure has been described in detail with reference to a display panel and a display device provided in the embodiments of the present disclosure. Specific examples are used herein to illustrate the principles and embodiments of the present disclosure. The description of the above embodiments is merely intended to help understand the technical proposals and the core idea of the present disclosure. At the same time, those skilled in the art may make modifications to the specific implementation modes and applying ranges based on concepts disclosed herein. In summary, the content of the description should not be construed as limiting the scope of the present disclosure.

What is claimed is:

1. A display panel, comprising a first baseplate and a second baseplate arranged opposite to each other, and a cholesteric liquid crystal arranged between the first baseplate and the second baseplate, wherein the display panel comprises a first pixel region, a second pixel region, and a third pixel region; and
the first baseplate comprises a first substrate and a first alignment layer arranged on a side of the first substrate close to the cholesteric liquid crystal, and the second baseplate comprises a second substrate and a second alignment layer arranged on a side of the second substrate close to the cholesteric liquid crystal;
wherein in the first pixel region, an alignment angle of the first alignment layer and an alignment angle of the second alignment layer have a first alignment angle difference; in the second pixel region, an alignment angle of the first alignment layer and an alignment angle of the second alignment layer have a second alignment angle difference; in the third pixel region, an alignment angle of the first alignment layer and an alignment angle of the second alignment layer have a third alignment angle difference; and any two of the first alignment angle difference, the second alignment angle difference, and the third alignment angle difference are different; and
a portion of the cholesteric liquid crystal located in the first pixel region has a first pitch, a portion of the cholesteric liquid crystal located in the second pixel region has a second pitch, a portion of the cholesteric liquid crystal located in the third pixel region has a third pitch, and any two of the first pitch, the second pitch, and the third pitch are different.

2. The display panel according to claim 1, wherein one of the first alignment layer and the second alignment layer comprises a first alignment component arranged in the first pixel region, a second alignment component arranged in the second pixel region, and a third alignment component arranged in the third pixel region; and an alignment angle of the first alignment component, an alignment angle of the second alignment component, and an alignment angle of the third alignment component are the same; and
the other one of the first alignment layer and the second alignment layer comprises a fourth alignment component arranged in the first pixel region, a fifth alignment component arranged in the second pixel region, and a sixth alignment component arranged in the third pixel region; and any two of an alignment angle of the fourth alignment component, an alignment angle of the fifth alignment component, and an alignment angle of the sixth alignment component are different.

3. The display panel according to claim 2, wherein the one of the first alignment layer and the second alignment layer has a uniform alignment angle across an entire surface.

4. The display panel according to claim 1, wherein one of the first alignment layer and the second alignment layer comprises a first alignment component arranged in the first pixel region, a second alignment component arranged in the second pixel region, and a third alignment component arranged in the third pixel region; and at least two of an alignment angle of the first alignment component, an alignment angle of the second alignment component, and an alignment angle of the third alignment component are different; and
the other one of the first alignment layer and the second alignment layer comprises a fourth alignment component arranged in the first pixel region, a fifth alignment component arranged in the second pixel region, and a sixth alignment component arranged in the third pixel region; and any two of an alignment angle of the fourth alignment component, an alignment angle of the fifth alignment component, and an alignment angle of the sixth alignment component are different.

5. The display panel according to claim 2, wherein the cholesteric liquid crystal is continuously arranged in any two of the first pixel region, the second pixel region, and the third pixel region.

6. The display panel according to claim 5, wherein the first baseplate is located on a display side of the display panel, the first baseplate further comprises a black matrix layer arranged on a side of the first alignment layer close to the first substrate, and in a top view of the display panel, the black matrix layer is arranged at a boundary between any two adjacent pixel regions among the first pixel region, the second pixel region, and the third pixel region.

7. The display panel according to claim 6, wherein in the top view of the display panel, any two adjacent alignment components of the fourth alignment component, the fifth alignment component, and the sixth alignment component partially overlap with the black matrix layer.

8. The display panel according to claim 2, wherein the display panel further comprises retaining walls arranged between the first baseplate and the second baseplate, the retaining walls are respectively arranged at a boundary between any two adjacent pixel regions among the first pixel region, the second pixel region, and the third pixel region, and the retaining walls separate the cholesteric liquid crystal.

9. The display panel according to claim 8, wherein a color of the retaining walls is black.

10. The display panel according to claim 8, wherein in a top view of the display panel, any two adjacent alignment components of the fourth alignment component, the fifth alignment component, and the sixth alignment component partially overlap with a respective one of the retaining walls.

11. The display panel according to claim 1, wherein the first baseplate further comprises a transparent electrode layer located between the first substrate and the first alignment layer, and the transparent electrode layer accesses a common voltage.

12. The display panel according to claim 1, wherein the second baseplate further comprises a plurality of pixel electrodes, a plurality of thin film transistors, and a driver circuit, and the driver circuit provides a driving voltage to the pixel electrodes of each pixel region.

13. A display device, comprising a display panel, and the display panel comprising a first baseplate and a second baseplate arranged opposite to each other, and a cholesteric liquid crystal arranged between the first baseplate and the second baseplate;
wherein the display panel comprises a first pixel region, a second pixel region, and a third pixel region; and
the first baseplate comprises a first substrate and a first alignment layer arranged on a side of the first substrate close to the cholesteric liquid crystal, and the second baseplate comprises a second substrate and a second alignment layer arranged on a side of the second substrate close to the cholesteric liquid crystal;
wherein in the first pixel region, an alignment angle of the first alignment layer and an alignment angle of the second alignment layer have a first alignment angle difference; in the second pixel region, an alignment angle of the first alignment layer and an alignment angle of the second alignment layer have a second alignment angle difference; in the third pixel region, an alignment angle of the first alignment layer and an alignment angle of the second alignment layer have a third alignment angle difference; and any two of the first alignment angle difference, the second alignment angle difference, and the third alignment angle difference are different; and
a portion of the cholesteric liquid crystal located in the first pixel region has a first pitch, a portion of the cholesteric liquid crystal located in the second pixel region has a second pitch, a portion of the cholesteric liquid crystal located in the third pixel region has a third pitch, and any two of the first pitch, the second pitch, and the third pitch are different.

14. The display device according to claim 13, wherein one of the first alignment layer and the second alignment layer comprises a first alignment component arranged in the first pixel region, a second alignment component arranged in the second pixel region, and a third alignment component arranged in the third pixel region; and an alignment angle of the first alignment component, an alignment angle of the second alignment component, and an alignment angle of the third alignment component are the same; and
the other one of the first alignment layer and the second alignment layer comprises a fourth alignment component arranged in the first pixel region, a fifth alignment component arranged in the second pixel region, and a sixth alignment component arranged in the third pixel region; and any two of an alignment angle of the fourth alignment component, an alignment angle of the fifth alignment component, and an alignment angle of the sixth alignment component are different.

15. The display device according to claim 13, wherein one of the first alignment layer and the second alignment layer comprises a first alignment component arranged in the first pixel region, a second alignment component arranged in the second pixel region, and a third alignment component arranged in the third pixel region; and at least two of an alignment angle of the first alignment component, an alignment angle of the second alignment component, and an alignment angle of the third alignment component are different; and
the other one of the first alignment layer and the second alignment layer comprises a fourth alignment component arranged in the first pixel region, a fifth alignment component arranged in the second pixel region, and a sixth alignment component arranged in the third pixel region; and any two of an alignment angle of the fourth alignment component, an alignment angle of the fifth alignment component, and an alignment angle of the sixth alignment component are different.

16. The display device according to claim 14, wherein the first baseplate is located on a display side of the display panel, the first baseplate further comprises a black matrix layer arranged on a side of the first alignment layer close to the first substrate, and in a top view of the display panel, the black matrix layer is arranged at a boundary between any two adjacent pixel regions among the first pixel region, the second pixel region, and the third pixel region.

17. The display device according to claim 16, wherein in the top view of the display panel, any two adjacent alignment components of the fourth alignment component, the fifth alignment component, and the sixth alignment component partially overlap with the black matrix layer.

18. The display device according to claim 14, wherein the display panel further comprises retaining walls arranged between the first baseplate and the second baseplate, the retaining walls are respectively arranged at a boundary between any two adjacent pixel regions among the first pixel region, the second pixel region, and the third pixel region, and the retaining walls separate the cholesteric liquid crystal.

19. The display device according to claim 18, wherein a color of the retaining walls is black.

20. The display device according to claim 18, wherein in a top view of the display panel, any two adjacent alignment components of the fourth alignment component, the fifth alignment component, and the sixth alignment component partially overlap with a respective one of the retaining walls.
